(19) United States
(12) Patent Application Publication
(10) Pub. No.: US 2025/0206525 A1
(43) Pub. Date: Jun. 26, 2025

(54) GRIPPER

(71) Applicant: OCADO INNOVATION LIMITED, Hatfield, Hertfordshire (GB)

(72) Inventor: Lars Sverker Ture LINDBO, Hatfield, Hertfordshire (GB)

(73) Assignee: OCADO INNOVATION LIMITED, Hatfield, Hertfordshire (GB)

(21) Appl. No.: 18/847,505

(22) PCT Filed: Mar. 7, 2023
(86) PCT No.: PCT/EP2023/055783

§ 371 Date: Sep. 16, 2024

(30) Foreign Application Priority Data
Mar. 17, 2022 (GB) 2203754.3

(51) Int. Cl. B65G 1/04

(52) U.S. Cl. CPC B65G 1/0457

(57) ABSTRACT

A gripper apparatus, and automated storage and retrieval system and related methods of use are provided. The gripper apparatus can be used for combining and separating carriers and storage container, the carrier having an open top and being able to be contained within the storage container. The apparatus can include first and second gripper arms, and a lifting device; wherein the gripper arms are configured and arranged to engage with opposing sidewalls of a carrier by exerting a clamping pressure on an interior of the opposing sidewalls of the carrier thereby gripping the carrier to enable the lifting device to lift the carrier and combine/separate the carrier with a storage container.

### FIELD OF THE INVENTION

The invention relates to a gripper apparatus. The gripper may be used in an automated storage and retrieval system. More particularly, the gripper may be used to automate storage of open top carriers such as trays, caddies, and crates.

### BACKGROUND

IFCO (International Food Container Organization) trays, and other similar reusable packing containers, are widely used for transporting fresh food produce. One reason they are popular is that they reduce the need for disposable products and packaging. As well as being reusable, trays are attractive to businesses because they are capable of being stacked in various configurations when full of produce. Some designs may be may be flatten when empty for more efficient storage and return transport.

In grocery retail, reusable plastic trays, such as IFCO trays, are often used, especially for produce and proteins. These normally arrive at the retail location on a pallet, stacked closely together.

Pallet goods and/or other multi-packs of inbound items are separated and placed, individually or in groups corresponding to their stock keeping unit (SKU) into separate storage containers for storage in the storage and retrieval system. In some forms of goods-to-man picking systems, for example, bins or other storage containers containing inventory and/or other items may be stored within, and retrieved from, a storage and retrieval system, in order to facilitate picking of items from the storage containers at picking stations.

In some automated systems, there is a need to transfer reusable trays and other carriers into bins, to be stored and eventually presented for picking.

Various forms of both fully- and semi-automated order processing and fulfilment systems are known. They, and the various components they comprise, may take many forms. For example:
EP 1037828 B1 (Autostore) describes a system in which stacks of containers are arranged within a frame structure. A system of this type is illustrated schematically in FIGS. 1 to 4 of the accompanying drawings. Robotic load handling devices can be controllably moved around the stack on a system of tracks on the uppermost surface of the stack.

A load handling device is described in UK Patent Application No. GB2520104A (Ocado Innovation Limited) where each robotic load handler only covers one grid space, thus allowing high density of load handlers and thus high throughput of a given size system.

In the known robotic picking systems described above, robotic load handling devices are controllably moved around the top of the stacks on a track system forming a grid. A given load handling device lifts a bin from the stack, the container being lifted containing inventory items needed to fulfil a customer order. The container is carried to a pick station where the required inventory item may be manually removed from the bin and placed in a delivery container, the delivery container forming part of the customer order, and being manually filled for dispatch at the appropriate time. At the pick station, the items may also be picked by industrial robots, suitable for such work, for example as described in UK Patent Application No GB2524383B-Ocado Innovation Limited.

As shown in FIGS. 1 and 2, stackable storage containers, known as bins 9, are stacked on top of one another to form stacks 11. The stacks 11 are arranged in a framework 3, 5, 7 in a warehousing or manufacturing environment. FIG. 1 is a schematic perspective view of the framework 3, 5, 7, and FIG. 2 is a top-down view showing a single stack 11 of bins 9 arranged within the framework 3, 5, 7. Each bin 9 typically holds a plurality of product or inventory items, and the inventory items within a bin 9 may be identical, or may be of different product types depending on the application. Furthermore, the bins 9 may be physically subdivided to accommodate a plurality of different inventory items.

The top level of the framework 3, 5, 7 a track structure 13 or rails arranged in a grid pattern across the top of the stacks 11. The track structure 13 supports a plurality of robotic load handling devices 31. A first set of parallel rails 17 guide movement of the load handling devices 31 in a first direction (X) across the top of the framework 3, 5, 7, and a second set of parallel rails 19, arranged perpendicular to the first set 17, guide movement of the load handling devices 31 in a second direction (Y), perpendicular to the first direction. In this way, the rails 17, 19 allow movement of the load handling devices 31 in two dimensions in the X-Y plane, so that a load handling device 31 can be moved into position above any of the stacks 11.

FIG. 3 shows a plurality of load-handling devices 31 moving on top of the storage structure 1.

As noted above, in some automated systems, there is a need to transfer reusable trays and other carriers into bins, to be stored and eventually presented for picking. Conventional means of automatically handling plastic trays typically require the grippers to handle the trays from the outside, making it difficult to carefully place them into the bins. For example, using a de-stacker device where an uppermost tray is clamped and moved on to a conveyor, or a lower tray is clamped lifted and the next lowermost tray is moved on to the conveyor.

It is against this background that the present invention has been devised.

The claimed, devices, apparatus, system and methods, are intended to provide improvements in relating to the automation of moving, lifting and storing open top carriers.

It will be appreciated that while the devices, apparatus, system and methods described herein are described using grocery systems as an example, automated or semi-automated storage and retrieval systems are not limited to systems directed to groceries. For example, the technology can be applied to shipping, baggage handling, vehicle parking, indoor or hydroponic greenhouses and farming, modular buildings, self-storage facilities, cargo handling, transport switchyards, manufacturing facilities, pallet handling, parcel sortation, airport logistics (ULD) and general logistics to name but a few possible applications. It will be appreciated that storage and retrieval systems of different types will have different technical requirements.

### SUMMARY OF THE INVENTION

Aspects of the invention are set out in the accompanying claims.

A gripper apparatus for combining and separating carriers and storage container is provided. Carriers may have an open top and are able to be contained within the storage container. The gripper apparatus may comprise: first and second gripper arms, and a lifting device; wherein the gripper arms are arranged to engage with opposing sidewalls of a carrier by exerting a clamping pressure on the interior of the opposing sidewalls of the carrier thereby gripping the carrier to enable the lifting device to lift the carrier and combine/separate the carrier with a storage container.

Carriers may comprise, for example, trays, caddies, boxes and crates. Typically, reusable carriers may be made from plastic, while some carriers which are more suitable for single use may be made from cardboard. Typically, while the construction is rigid, the carrier may be slightly flexible especially the vertical sidewalls, and especially if the carrier is designed to be lightweight or using a minimal amount of material. Thus, if a pressure or force is applied to the side walls they may bend slightly. Exploiting this unintended characteristic of carriers, by applying a pressure to opposite side walls it is possible to grasp or grip the carrier. Where gripper arms are connected to a lifting device, once gripped it may be possible to lift the carrier to place the carrier within a storage container.

The gripper arms may comprise a pivot point or joint. Therefore, the end of the gripper arms may provide a pressure by actuating the gripper arm at the joint.

It will be appreciated that it is sometimes beneficial to keep products in the storage containers in open top cardboard boxes. One example is glass bottles, which unrestrained would potentially fall over or roll around when the storage container is being transported. Keeping the bottles in an open top carrier may greatly reduce the risk of bottles breaking.

In other situations, products may arrive in boxes such as cardboard boxes. At product induct or a decant station, workers may open the box and remove the top and decide to otherwise leave the box intact. In this way, the box may be effectively made into a carrier of the type suitable to be handled by the gripper apparatus.

Where the carrier is only slightly smaller in area compared with the interior of the storage container, it will be appreciated that there may be limited space for the gripper arms to place the carrier carefully within the storage container. Accordingly, the gripper arms are arranged to be inserted into the carrier and apply an outward, or spreading clamping pressure on the side walls of the carrier. In this way, the lifting device may lower the carrier into the storage container until it is resting on the bottom of the storage container, before disengaging the sidewalls of the carrier. In this way, the gripper apparatus may avoid dropping the carrier and items contained therein.

Further, the gripper apparatus may be used to separate a combined carrier and storage container by operating in reverse. That is, the gripper arms may be inserted into the carrier and apply a clamping or spreading pressure to grip the carrier and then lift the carrier from the storage container.

A gripper apparatus may further comprise first and second plates corresponding to the first and second gripper arms respectively, wherein the plates are arranged to be positioned on the exterior of the opposing sidewalls of the carrier in-line with respective gripper arms and separated by a gap to accommodate the opposing side walls of the carrier such when a clamping or spreading pressure is applied to the interior of opposing side walls, bend of the opposing side walls is limited by the plates.

The plates may be thin so that they may be inserted easily between the carrier and a storage container.

In this way, when a clamping or spreading force is applied by the gripper arms, the sidewalls of the carrier may be ‘pinched’ between the gripper arms and the plates. Such an approach may avoid excessive deforming/bending/flexing of the side walls of the carrier. This may be advantageous where the carrier is similar in size to the interior of the storage container because putting a pressure on the sidewalls may cause them to press against the interior of the storage container making it difficult to lift the carrier from the storage container. By reducing the flex of the carrier side walls it may be easier to slide the carrier in and out of the storage container while providing sufficient force for enabling lifting of the carrier.

A gripper apparatus may further comprise an alignment mechanism for aligning the gripper arms with opposing sidewalls of the carrier.

In this way, the gripper apparatus may ensure that the gripper arms accurately engage with the sidewalls of a carrier. It will be appreciated, that due to the potentially relatively delicate nature of the carrier sidewalls, without accurate alignment, the gripper apparatus could damage the carrier sidewalls.

The distal end of each of the gripper arms may comprise a clamping arrangement having two pivotally joined fingers biased to provide a clamping force, and arranged to be pushed apart to release.

The fingers may be biased in an open position with spring between the fingers. The fingers may be pushed apart by a pneumatic or hydraulic cylinder, for example. It will be appreciated that any suitable actuator may be used to overcome the bias position of the fingers. Another example is an electromagnetic switch.

At least one of the first and second gripper arms may be mounted a slidable member for adjusting the distance between the first and second gripper arms to substantially match the distance between opposing sidewalls of the carrier.

Both the first and second gripper arms may be mounted on a slidable member.

It will be appreciated the gripper apparatus may be made with a fixed distance between the gripper arms, without the need for a slidable member. This may be useful when standard sized carriers or trays are regularly received. Fixed distance gripper apparatus may be cheaper or more reliable that variable distance gripper apparatus.

It will be appreciated, that variable distance gripper apparatus may be more versatile and able to lift more forms of carriers. Moreover, adjusting the position of both gripper arms using the slidable members may allow a lifted load to be centred or balanced as it is lifted by the gripper assembly.

A gripper apparatus may further comprise a connector for mounting the gripper apparatus to a robotic arm.

In this way, the gripper apparatus may be flexibly positioned to engage with carriers as they arrive. The mounting may comprise a robotic arm, base plate and gripper arm mounts. The gripper arm mounts may be attached to the base plate.

The engagement surface of the gripper arms may comprise a friction surface.

It will be appreciated that a higher friction surface will aid in gripping the carrier, making the gripper apparatus more reliable for lifting and moving carriers to combine and separate with storage containers.

A gripper apparatus may further comprise a second set of first and second gripper arms.

In this way, the gripper apparatus may engage with two carriers at the same time, or the sets of gripper arms may operate independently. Such an arrangement may be particularly useful when carriers are arranged in a regular formation on a pallet.

Sets of gripper arms may operable together or independently. Further, the first and second gripper arm within a single set may operate together or independently. Considering a gripper apparatus with two sets of gripper arms, the gripper arms may be arranged to grip and lift two half sized carriers, or the gripper arms may be arranged to grip and lift a single larger carrier. Or the gripper apparatus may operate to grip and lift a single half sized tray.

It will be appreciated that a gripper apparatus could have a number of first and second gripper arm sets. Advantageously, the number of sets of gripper arms and their arrangement could be arranged to match the typical number and arrangement of carriers on a pallet.

An automated storage and retrieval system is provided, comprising: a three dimensional grid framework structure comprising a plurality of upright members arranged to form a plurality of vertical storage columns for one or more combined carriers and storage containers and one or more storage containers to be stacked between the upright members and be guided by the upright members in a vertical direction, wherein the plurality of upright members are interconnected by a plurality of grid members arranged in a grid pattern to form a grid structure comprising a plurality of grid cells; the three dimensional grid framework structure further comprising at least one port being arranged for delivering a storage container or a combined carrier and storage container to a gripper apparatus and or being arranged for receiving a storage container or a combined carrier and storage container from said gripper apparatus; and one or more load handling devices operative on the grid structure for transporting a combined carrier and storage container to the at least one port and/or for picking up a combined carrier and storage container from the at least one port, each of the one or more load handling devices comprising a lifting device for lifting and/or lowering a combined carrier and storage container or storage container, said gripper apparatus being arranged to combine carriers and storage containers and or to separate carriers from storage containers.

It will be appreciated that the at least one port may be a corresponding number of the plurality of vertical storage columns. In this way, the storage containers or combined carrier and storage containers may move through a grid cell in a vertical direction.

In other arrangements, the at least one port may be a drop-off/pick-up point on a conveyor operating horizontally, or substantially horizontally.

It will be appreciated that the plurality of vertical storage columns may store delivery containers or delivery totes (DT). Storage containers may be referred to as storage totes (ST).

In this way, the gripper apparatus may be used in an automated storage and retrieval system. The gripper apparatus may be useful for decant or inbound in order to induct items into the system until they are required for an order.

It will be appreciated that the system may comprise a number of gripper apparatus, and the number will be proportional to the size of the system and depend on the peak demand. The demand for gripper apparatus may not be consistent over a period of a day, week or month depending on the types of items or products, and when supply is delivered.

An automated storage and retrieval system may comprise: at least one variable distance gripper apparatus, and at least one fixed distance gripper apparatus.

It will be appreciated that variable distance gripper apparatus are likely to be more expensive and less reliable than fixed distance gripper apparatus. Also, that variable distance gripper apparatus will be more versatile and flexible for the type of carriers that may be gripped and lifted in order to combine and separate from a storage container. Accordingly, an automated storage and retrieval system may be designed with several gripper apparatus. Typically, in a ratio of several fixed distance gripper apparatus to deal with carriers which are consistently stored in the automated storage and retrieval system to one variable distance gripper apparatus to deal with less frequent carriers of less typical size.

A method of operating an automated storage and retrieval system is provided. The method may comprise the steps of:
receiving one or more carriers of items to be stored in the system;
transporting a storage container though a port to the gripper apparatus;
combining the carrier with the storage container; and
transporting the combined carrier and storage container through a port towards the grid structure, OR the method comprising the steps of:
transporting a combined carrier and storage container through port to the gripper apparatus;
separating the carrier and storage container; and
transporting the storage container through a port towards the grid structure.

In this way, carriers may be combined with storage containers when they arrive at the automated storage and retrieval system, so that they may be stored within the system. When items have been removed from the carriers, for example, when demanded by an order and picked and a pick station, the combined carrier and storage container can be returned to the grabber apparatus to be separated. It will be appreciated that some grabber apparatus may be dedicated to combining carriers and storage container, and other grabber apparatus may be dedicated to separating carriers and storage containers. Or grabber apparatus may be assigned to carry out both combination and separation of carriers with storage containers.

The storage container or the combined carrier and storage container may be transported in a vertical direction by the lifting device of the one or more load handling devices operating on the grid structure.

In this way, the combined carrier and storage container may be stored within the storage system.

Accordingly, a gripper apparatus suitable for using in an automated storage and retrieval system is provided. The gripper apparatus may be used for decant and induction of items to be stored in the system. Thus, improvements in efficiency operating storage and retrieval systems. In particular, improvements in automation of the handling of open top carriers or containers, and induction of items into the storage facility.

Other variations and advantages will become apparent from the following description.

### BRIEF DESCRIPTION OF THE DRAWINGS

These and other aspects of the invention will now be described, by way of example only, and with reference to the accompanying drawings, in which:

FIG. 1 is a schematic perspective view of a grid storage structure and containers;

FIG. 2 is a schematic plan view of a track on top of the storage structure of FIG. 1;

FIG. 3 shows load handling devices on top of the storage structure of FIG. 1;

FIG. 4 is a schematic perspective view of a single load handling device with a lifting mechanism in a lowered configuration;

FIG. 5 shows schematic cutaway views of the load handling device of FIG. 4 with the lifting mechanism in a raised (FIG. 5a) and a lowered (FIG. 5b) configuration;

FIG. 6a shows a carrier; FIG. 6b shows a number of carriers arranged on a pallet; FIG. 6c shows a carrier placed inside a bin, storage container or storage tote (ST);

FIG. 7 shows a carrier containing produce, with gripper arms;

FIG. 8 shows a carrier, with gripper arms and plates;

FIG. 9 shows a carrier inside a storage tote, with gripper arms;

FIG. 10 shows a detail of a claiming gripper; and

FIG. 11 shows a gripper assembly, with two grippers each mounted on adjustable members.

In the figures, like features are denoted by like reference signs where appropriate.

### DETAILED DESCRIPTION

The following embodiments represent preferred examples of how the invention may be practiced, but they are not necessarily the only examples of how this could be achieved. These examples are described in sufficient detail to enable those skilled in the art to practice the invention. Other examples may be utilised and structural changes may be made without departing from the scope of the invention as defined in the appended claims. Moreover, direction references and any other terms having an implied orientation are given by way of example to aid the reader's understanding of the particular examples described herein. They should not be read to be requirements or limitations, particularly as to the position, orientation, or use of the invention unless specifically set forth in the appended claims. Similarly, connection references (e.g., attached, coupled, connected, joined, secured, and the like) are to be construed broadly and may include intermediate members between a connection of elements and relative movement between elements. As such, connection references do not necessarily infer that two elements are directly connected and in fixed relation to each other, unless specifically set forth in the appended claims. Similarly, wording such as “movement in the n-direction” and any comparable wording, where n is one of x, y or z, is intended to mean movement substantially along or parallel to the n-axis, in either direction (i.e., towards the positive end of the n-axis or towards the negative end of the n-axis).

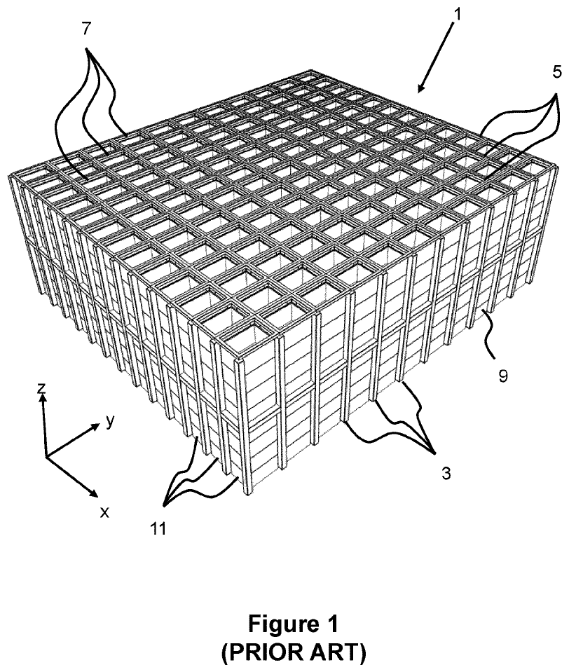

FIG. 1 illustrates a storage structure 1 of a storage and retrieval system. The storage structure 1 comprises a framework comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells 14. In the illustrated example, storage containers 9 are arranged in stacks 11 beneath the grid cells 14 defined by the grid pattern, one stack 11 of containers 9 per grid cell 14.

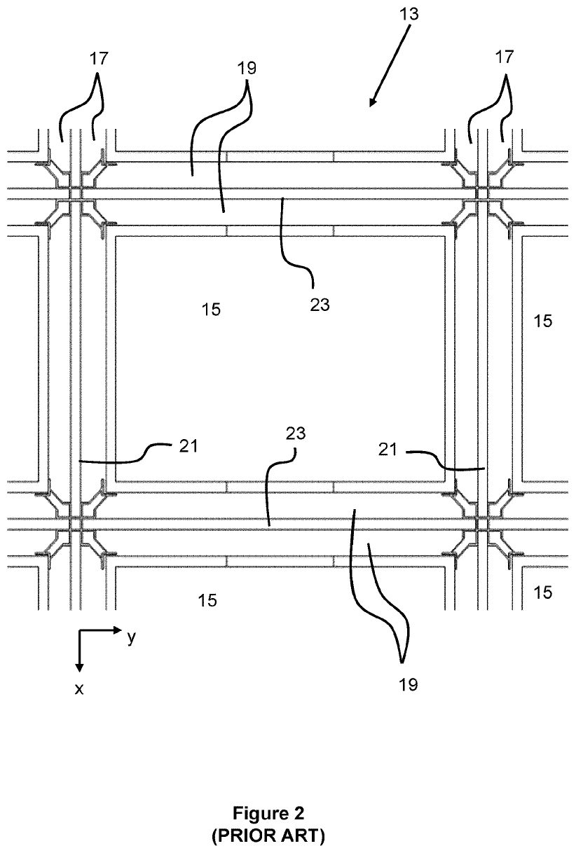

FIG. 2 shows a large-scale plan view of a section of track structure 13 forming part of the storage structure 1 illustrated in FIG. 1 and located on top of the horizontal members 5, 7 of the storage structure 1 illustrated in FIG. 1. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells 14. The apertures 15 are sized to allow containers 9 located beneath the grid cells 14 to be lifted and lowered through the apertures 15. The x-direction tracks 17 are provided in pairs separated by channels 21, and the y-direction tracks 19 are provided in pairs separated by channels 23. Other arrangements of track structure may also be possible.

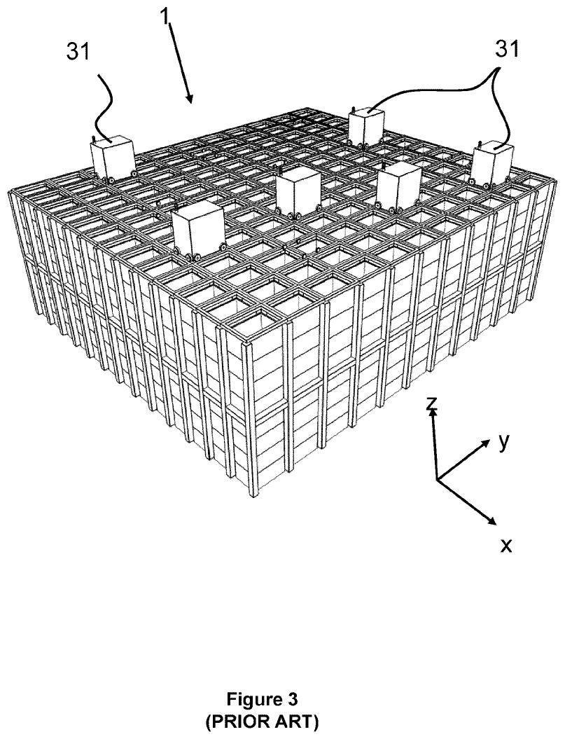

FIG. 3 shows a plurality of load handling devices 31 moving on top of the storage structure 1 illustrated in FIG. 1. The load handling devices 31, which may also be referred to as robots or bots, are provided with sets of wheels to engage with corresponding x- or y-direction tracks 17, 19 to enable the bots 31 to travel across the track structure 13 and reach specific grid cells 14. The illustrated pairs of tracks 17, 19 separated by channels 21, 23 allow bots 31 to occupy (or pass one another on) neighbouring grid cells 14 without colliding with one another.

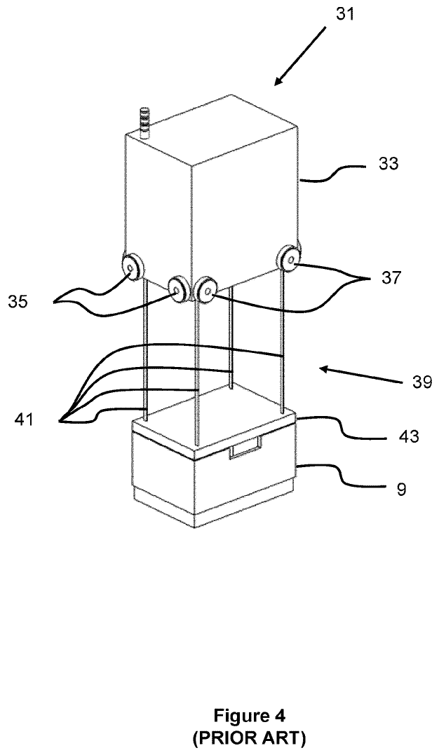

As illustrated in FIG. 4, a bot 31 comprises a body 33 in or on which are mounted one or more components which enable the bot 31 to perform its intended functions. These functions may include moving across the storage structure 1 on the track structure 13 and raising or lowering containers 9 (e.g. from or to stacks 11) so that the bot 31 can retrieve or deposit containers 9 in specific locations defined by the grid pattern.

The illustrated bot 31 comprises a driving assembly comprising first and second sets of wheels 35, 37 which are mounted on the body 33 of the bot 31 and enable the bot 31 to move in the x- and y-directions along the tracks 17 and 19, respectively. In particular, two wheels 35 are provided on the shorter side of the bot 31 visible in FIG. 4, and a further two wheels 35 are provided on the opposite shorter side of the bot 31. The wheels 35 engage with tracks 17 and are rotatably mounted on the body 33 of the bot 31 to allow the bot 31 to move along the tracks 17. Analogously, two wheels 37 are provided on the longer side of the bot 31 visible in FIG. 4, and a further two wheels 37 are provided on the opposite longer side of the bot 31. The wheels 37 engage with tracks 19 and are rotatably mounted on the body 33 of the bot 31 to allow the bot 31 to move along the tracks 19.

The bot 31 also comprises a lifting mechanism 39 configured to raise and lower containers 9. The illustrated lifting mechanism 39 comprises four tethers 41 which are connected at their lower ends to a gripping device 43. The tethers 41 may be in the form of cables, ropes, tapes, or any other form of tether with the necessary physical properties to lift the containers 9. The gripping device 43 comprises a gripping mechanism configured to engage with features of the containers 9. For example, the containers 9 may be provided with one or more apertures in their upper sides with which the gripping mechanism can engage. Alternatively or additionally, the gripping mechanism may be configured to hook under the rims or lips of the containers 9, and/or to clamp or grasp the containers 9. The tethers 41 may be wound up or down to raise or lower the gripping device 43, as required. One or more motors or other means may be provided to effect or control the winding up or down of the tethers 41.

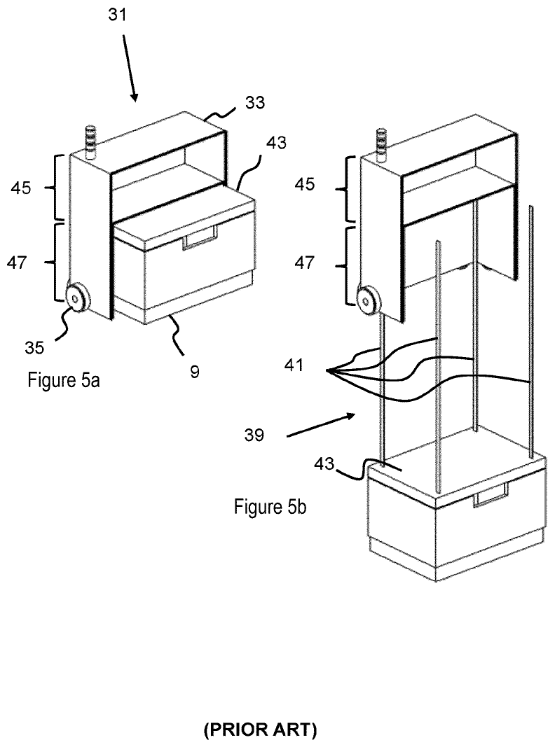

As can be seen in FIG. 5, the body 33 of the illustrated bot 31 has an upper portion 45 and a lower portion 47. The upper portion 45 is configured to house one or more operation components (not shown), such as components (e.g. motors) of the lifting mechanism, wireless communication components, etc. The lower portion 47 is arranged beneath the upper portion 45. The lower portion 47 comprises a container-receiving space or cavity for accommodating at least part of a container 9 that has been raised by the lifting mechanism 43. The container-receiving space is sized such that enough of a container 9 can fit inside the cavity to enable the bot 31 to move across the track structure 13 on top of storage structure 1 without the underside of the container 9 catching on the track structure 13 or another part of the storage structure 1. When the bot 31 has reached its intended destination, the lifting mechanism 43 controls the tethers 41 to lower the gripping device 43 and the corresponding container 9 out of the cavity and into the intended position. The intended position may be a stack 11 of containers 9 or an egress point of the storage structure 1 (or an ingress point of the storage structure 1 if the bot 31 has moved to collect a container 9 for storage in the storage structure 1). Although in the illustrated example the upper and lower portions 45, 47 are separated by a physical divider, in other examples, the upper and lower portions 45, 47 may not be physically divided by a specific component or part of the body 33 of the bot 31.

The container-receiving space of the bot 31 may not be within the body 33 of the bot 31. For example, the container-receiving space may instead be adjacent to the body 33 of the bot 31, e.g. in a cantilever arrangement with the weight of the body 33 of the bot 31 counterbalancing the weight of the container to be lifted. In such embodiments, a frame or arms of the lifting mechanism 43 may protrude horizontally from the body 33 of the bot 31, and the tethers 41 may be arranged at respective locations on the protruding frame/arms and configured to be raised and lowered from those locations to raise and lower a container into the container-receiving space adjacent to the body 33. The height at which the frame/arms is/are mounted on and protrude(s) from the body 33 of the bot 31 may be chosen to provide a desired effect. For example, it may be preferable for the frame/arms to protrude at a high level on the body 33 of the bot 31 to allow a larger container (or a plurality of containers) to be raised into the container-receiving space beneath the frame/arms. Alternatively, the frame/arms may be arranged to protrude lower down the body 33 (but still high enough to accommodate at least one container between the frame/arms and the track structure 13) to keep the centre of mass of the bot 31 lower when the bot 31 is loaded with a container.

To enable the bot 31 to move on the different wheels 35, 37 in the first and second directions, the driving assembly further comprises a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load handling device 31 to selectively move in either the first direction or the second direction across the tracks 17, 19 of the storage structure 1.

The wheel-positioning mechanism may include one or more linear actuators, rotary components or other means for raising and lowering at least one set of wheels 35, 37 relative to the body 33 of the bot 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the bot 31 stays substantially at the same height and therefore the weight of the body 33 and the components mounted thereon does not need to be lifted and lowered by the wheel-positioning mechanism.

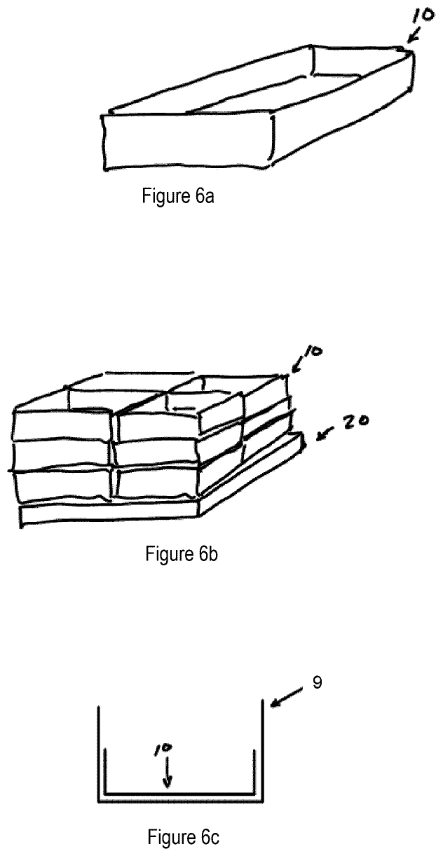

As mentioned above, fresh food produce often arrives at storage facilities, or Customer Fulfilment Centres (CFCs), in IFCO trays and other forms of open top carriers or containers. FIG. 6a shows a carrier 10 that may be used for the purpose of delivering fresh food produce to a CFC. Typically, such carriers 10 will arrive on a pallet 20, as illustrated in FIG. 6b. As shown, twelve carriers 10 are arranged in a 2×2 arrangement, having three layers. Of course, other arrangements of carriers 10 on pallets 20 are anticipated.

For storage in an automated retrieval system as described above, a carrier 10 is placed within a storage container or storage tote (ST) 9, as shown in FIG. 6c.

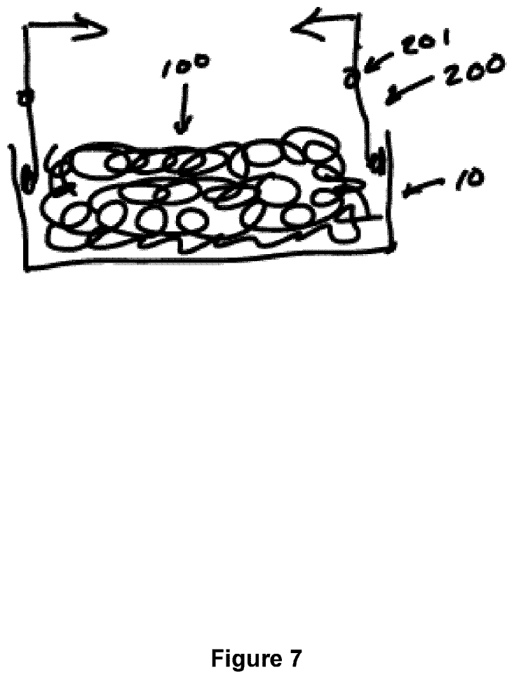

FIG. 7 shows a carrier 10 containing produce 100. Gripper arms 200 are inserted into the top of the carrier 10. The gripper arms 200 are arranged a distance apart to substantially match the width of the carrier 10. Once inserted, the end of the gripper arms 200 are actuated to push against opposed sidewalls of the carrier 10, pivoting about joint 201. In this way, the gripper arms 200 push against the sidewalls possibly causing a slight flexing of the sidewalls to grip the carrier 10.

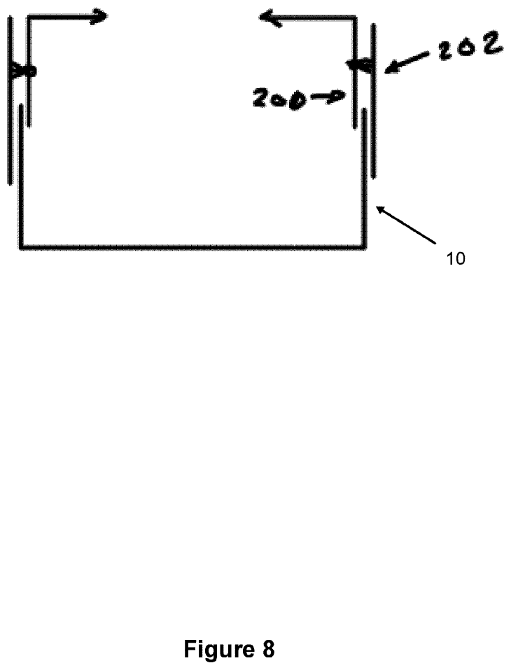

FIG. 8 shows a carrier 10 and gripper arms 200, similarly to FIG. 7. As mentioned above, carrier 10 may be plastic or alternatively cardboard. Cardboard in particular may have a tendency to flex or bend when a pressure is applied. In order to limit the amount by which the sidewalls flex when a pressure is applied, the gripper apparatus is further provided with plates 202. The plates 202 are connected to the gripper arms 200 at the joint 201. The plates 202 are held substantially vertically. When the gripper apparatus is positioned to grip a carrier 10, the plates 202 are positioned to the exterior of the sidewalls of the carrier 10, while the ends of the gripper arms 200 are positioned to the interior of the sidewalls of the carrier 10. Thus, the gripper apparatus is positioned each side of the sidewalls. When the gripper arms 200 are actuated to apply a spreading or outwards pressure (clamping pressure) on the sidewalls, the sidewalls are prevented from flexing excessively. Instead, the deflection of the sidewalls of the carrier 10 is limited by the plates 202.

Accordingly, the gripper arrangement as shown in FIG. 7 or 8 is able to grip and pick up a carrier 10 by the edges or sidewalls of the carrier 10. The carrier 10 may then be lifted by the gripper arrangement and placed in a storage container 9.

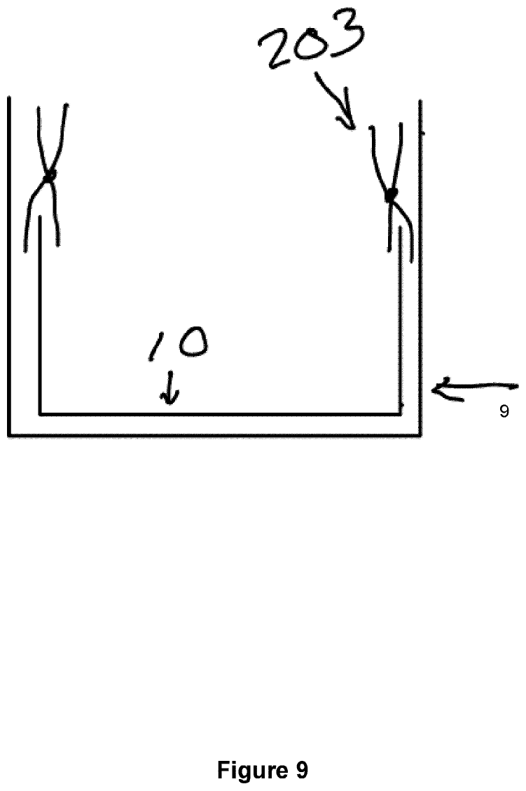

FIG. 9 shows a carrier 10 inside a storage container 9. It will be appreciated that a carrier 10 may be lifted from a storage container 9 by applying the gripper apparatus 203 to the carrier 10 inside the storage container 9. In the arrangement shown in FIG. 9, the end of the gripper arms comprises a pincer arrangement, with two grippers pivotally attached at a join. In use, the two grippers of each of the gripper arms are arranged to the interior of the sidewalls of the carrier 10 and to the exterior of the side walls, between the carrier 10 and the storage container 9. In this way, the gripper arrangement may grip and lift the carrier 10 by the upper edge of the sidewalls and does not need to grab the carrier 10 from the sides, which would be difficult when the carrier 10 is inside a storage container 9. This type of gripper apparatus may be referred to as a clamping type gripper.

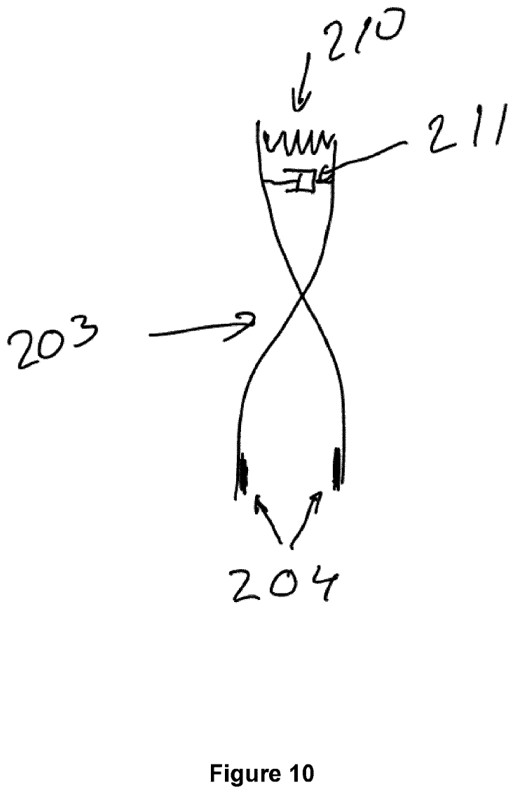

FIG. 10 shows the clamping gripper 203 of FIG. 9 in more detail. The grippers are joined substantially at their centre by a pivoting joint. At the upper end (above the joint), the grippers are separated by a spring 210 and a cylinder 211. The spring 210 provides a force to claim the lower ends (below the joint) of the grippers together, i.e. the spring 210 provides a clamping force. The cylinder 211 may be pneumatic or hydraulic and used to provide a force to overcome the spring 210 thus opening the lower ends of the grippers. The cylinder 211 may be operated to open and close the grippers as required. The lower ends of the gripper further comprise friction surfaces 204 which face together to give better grip of a carrier 10.

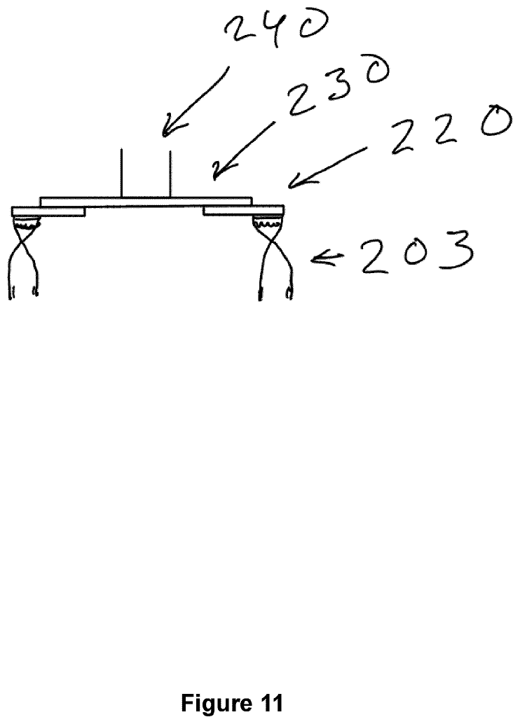

FIG. 11 shows a gripper assembly for connecting to a robotic arm which may be used at a decant station in an automated storage and retrieval system. The connector 240 allows the gripper assembly to be connected to a robot arm. A base plate 230 is attached to the connector 240, on which the other gripper assembly components are attached. As shown in FIG. 11, two grippers 203 are attached to opposite sides of the base plate 230, and the distance between the grippers 203 is approximately equal to the width of a typical carrier 10. In this instance, between the base plate 230 and each of the grippers 203 there is an adjustable member 220. The adjustable members 220 slide horizontally to extend or decrease the distance between the grippers in order to match the width of a carrier 10 which is to be gripped and lifted.

While the arrangement in FIG. 11 shows each gripper 203 mounted on an adjustable member 220, it will be appreciated that it is necessary for only one of the grippers 203 to be mounted on an adjustable member 220 for the gripper assembly to be of variable distance to match a variety of carriers 10. Furthermore, it will be appreciated that both grippers 203 of a single gripper assembly may be mounted directly to the base plate 230 (without adjustable member(s) 220) in a fixed distance gripper assembly arrangement.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

It will be appreciated that a cam mechanism can be designed for a particular application using various combinations of devices and arrangements described above. It will be appreciated that the features described hereinabove may all be used together in a single system. In other embodiments of the invention, some of the features may be omitted. The features may be used in any compatible arrangement. Many variations and modifications not explicitly described above are possible without departing from the scope of the invention as defined in the appended claims.

1. A gripper apparatus for combining and separating a carrier and a storage container, the carrier having an open top and being able to be contained within the storage container, the gripper apparatus comprising:
first and second gripper arms; and
a lifting device;
wherein the gripper arms are configured and arranged to exert a clamping pressure on an interior of opposing sidewalls of a carrier to thereby grip a carrier to enable the lifting device to lift a carrier and combine/separate a carrier relative to a storage container.

2. A gripper apparatus according to claim 1, comprising:
first and second plates corresponding to the first and second gripper arms respectively, wherein the plates are configured and arranged to be positioned on an exterior of opposing sidewalls of a carrier in-line with respective gripper arms and separated by a gap to accommodate opposing side walls of a carrier such that when a clamping pressure is applied to interior opposing side walls of a carrier, a bending of opposing side walls of that carrier will be limited by the plates.

3. A gripper apparatus according to claim 1, comprising:
an alignment mechanism for aligning the gripper arms with opposing sidewalls of a carrier.

4. A gripper apparatus according to claim 1, wherein a distal end of each of the gripper arms comprises:
a clamping arrangement having two pivotally joined fingers biased to provide a clamping force, and arranged to be pushed apart to release.

5. A gripper apparatus according to claim 1, wherein at least one of the first and second gripper arms is mounted as a slidable member for adjusting a distance between the first and second gripper arms to substantially match a distance between opposing sidewalls of a carrier.

6. A gripper apparatus according to claim 1, comprising:
a connector for mounting the gripper apparatus to a robotic arm.

7. A gripper apparatus according to claim 1, wherein an engagement surface of each of the gripper arms comprises:
a friction surface.

8. A gripper apparatus according to claim 1, comprising:
a second set of first and second gripper arms.

9. A gripper apparatus according to claim 1, in combination with an automated storage and retrieval system, comprising:
a three dimensional grid framework structure including a plurality of upright members configured and arranged to form a plurality of vertical storage columns for one or more combined carriers and storage containers and one or more storage containers to be stacked between the upright members and be guided by the upright members in a vertical direction, wherein the plurality of upright members are interconnected by a plurality of grid members arranged in a grid pattern to form a grid structure containing a plurality of grid cells;
the three dimensional grid framework structure including at least one port configured and arranged for delivering a storage container or a combined carrier and storage container to the gripper apparatus and/or being configured and arranged for receiving a storage container or a combined carrier and storage container from said gripper apparatus; and
one or more load handling devices operative on the grid structure for transporting a combined carrier and storage container to the at least one port and/or for picking up a combined carrier and storage container from the at least one port, each of the one or more load handling devices including a lifting device for lifting and/or lowering a combined carrier and storage container or storage container,
said gripper apparatus being arranged to combine carriers and storage containers and or to separate carriers from storage containers.

10. An automated storage and retrieval system according to claim 9, wherein at least one of the first and second gripper arms is mounted as a slidable member for adjusting a distance between the first and second gripper arms to substantially match a distance between opposing sidewalls or a carrier; and
wherein the distance between the gripper arms is fixed at a predetermined distance.

11. A method of operating an automated storage and retrieval system having a grid structure and a gripper apparatus for combining and separating a carrier and a storage container, the carrier having an open top and being able to be contained within the storage container, the gripper apparatus including:
first and second gripper arms; and
a lifting device;
wherein the gripper arms are configured and arranged to exert a clamping pressure on an interior of opposing sidewalls of carrier to thereby grip a carrier to enable the lifting device to lift a carrier and combine/separate a carrier relative to a storage container, the method comprising:
receiving one or more carriers of items to be stored in the storage and retrieval system;
transporting a storage container though a port to the gripper apparatus;
combining the carrier with the storage container; and
transporting the combined carrier and storage container through a port towards the grid structure.

12. The method according to claim 11, wherein the storage container or the combined carrier and storage container is transported by a lifting device of one or more load handling devices operating on the grid structure.

13. A method of operating an automated storage and retrieval system having a grid structure and a gripper apparatus for combining and separating a carrier and a storage container, the carrier having an open top and being able to be contained within the storage container, the gripper apparatus including:
first and second gripper arms; and
a lifting device;
wherein the gripper arms are configured and arranged to exert a clamping pressure on an interior of opposing sidewalls of carrier to thereby grip a carrier to enable the lifting device to lift a carrier and combine/separate a carrier relative to a storage container, the method comprising:
transporting a combined carrier and storage container through port to the gripper apparatus;
separating the carrier and storage container; and
transporting the storage container through a port towards the grid structure.

14. The method according to claim 13, wherein the storage container or the combined carrier and storage container is transported by a lifting device of one or more load handling devices operating on the grid structure.
